(19) United States
(12) Patent Application Publication
(10) Pub. No.: US 2014/0109062 A1
(43) Pub. Date: Apr. 17, 2014

(54) SYSTEM AND METHOD TO PROVIDE COMPLIANCE SCRUTINY AND IN-DEPTH ANALYSIS OF A SOFTWARE APPLICATION

(71) Applicant: Tata Constultancy Services Limited, Mumbai (IN)

(72) Inventor: Ravi Mahamuni, Pune (IN)

(73) Assignee: Tata Constultancy Services Limited Mumbai, Mumbai (IN)

(21) Appl. No.: 14/046,670

(22) Filed: Oct. 4, 2013

(30) Foreign Application Priority Data
Oct. 11, 2012 (IN) 2992/MUM/2012

(51) Int. Cl. G06F 11/36

(52) U.S. Cl. CPC G06F 11/3616
USPC 717/126

(57) ABSTRACT

The present disclosure in general relates to a software compliance analysis and in particular to a system and method to provide compliance scrutiny and in-depth analysis of a software application. In one embodiment, a software compliance analysis method is disclosed, comprising: allowing a user to select one or more industry compliance standards with respect to a particular safety level; initiating a compliance verification process for the software application with respect to one or more normative parameters associated with the safety level; mapping the selected compliance standards with features of one or more analysis tools; analyzing only the mapped features of the one or more analysis tools to calculate a compliance level for the software application; and visually representing compliance of the software application in a multi-stage manner providing one or more suggestive measures to meet a desired compliance level.

### PRIORITY CLAIM

This U.S. patent application claims priority under 35 U.S.C. §119 to: India Application No. 2992/MUM/2012, filed Oct. 11, 2012. The aforementioned application is incorporated herein by reference in its entirety.

### TECHNICAL FIELD

The present disclosure in general relates to a software compliance analysis and in particular to a system and method to provide compliance scrutiny and in-depth analysis of a software application.

### BACKGROUND

In today's world every enterprise or industry implements software applications or tools for automation of manufacturing, production or any other business process. To ensure that the principles involved in quality assurance of the software application or tool like, ‘Fit for Purpose’ and ‘First time Right’ are complied or not, a software quality audit is a necessity.

In order to compute the quality level of software application, various standards have been defined such as ISO standards of different criticality levels. Software standard specifications define various rules to be complied with by a software application. There are various systems available in the markets that are configured to monitor the compliance of a software application and calculate their compliance level.

Various compliance monitoring and analysis tools exist in the market that compare the compliance standard specifications to calculate the overall compliance level of the software application under test. The software standard specifications are complex in nature and thus understanding them is difficult for a software developer. Also, manually mapping these specifications with various features of a software tool is tedious and time-consuming. In order to calculate the overall compliance level of a software application each developer using the tool should follow the same standard specifications. Thus, the mapping of the features should be uniform throughout the software tool in order to ensure consistency across a team. The existing software compliance monitoring and analysis tools calculate and visually represent the compliance level at the tool level.

### SUMMARY

The present disclosure provides an integrated system providing compliance scrutiny and analysis of a software application, result of said analysis visually represented to demonstrate in-depth traceability. In one embodiment, a software compliance analysis system is disclosed, comprising: a processor; and a memory storing processor-executable instructions, the instructions comprising: a selection module configured to allow a user to select one or more industry compliance standards with respect to a particular safety level; an execution module configured to initiate a compliance verification process for a software application with respect to one or more normative parameters associated with the safety level; a mapping module configured to map the selected compliance standards with features of one or more analysis tools; an analytics engine configured to analyze the mapped features of the one or more analysis tools to calculate a compliance level for the software application; and an output generation module configured to visually represent compliance of the software application in a multi-stage manner providing one or more suggestive measures to meet a desired compliance level.

The present disclosure also provides a method providing compliance scrutiny and analysis of a software application, result of said analysis visually represented to demonstrate in-depth traceability. In one embodiment, a software compliance analysis method is disclosed, comprising: allowing a user to select one or more industry compliance standards with respect to a particular safety level; initiating a compliance verification process for the software application with respect to one or more normative parameters associated with the safety level; mapping the selected compliance standards with features of one or more analysis tools; analyzing only the mapped features of the one or more analysis tools to calculate a compliance level for the software application; and visually representing compliance of the software application in a multi-stage manner providing one or more suggestive measures to meet a desired compliance level.

The present disclosure also provides a computer program product, with embedded set of instructions, for determining a compliance level with respect to a software quality certification. In one embodiment, a non-transitory computer-readable medium is disclosed, storing computer-executable instructions, the instructions comprising instructions for: a user interface configured to receive a selection from a user of one or more industry compliance standards with respect to a particular safety level; a compliance level determination module configured to execute a mapping of the selected compliance standards with features of one or more analysis tools; a display module configured to visually represent a compliance level of said software application in a multi-layer manner, such that each layer corresponds to the mapping, the display module further configured to display suggestive measures to the user for each rule violation to meet a desired compliance level.

### BRIEF DESCRIPTION OF DRAWINGS

FIG. 1 illustrates the architecture of an integrated system providing compliance scrutiny and analysis of a software application in accordance with an embodiment of the disclosure.

FIG. 2 illustrates the architecture of the output generation module providing detailed visual representation of compliance verification in accordance with an embodiment of the disclosure.

FIG. 3 illustrates the detailed visualization of the compliance level in a multi-stage manner in accordance with an exemplary embodiment of the disclosure.

FIG. 4 is a block diagram of an exemplary computer system for implementing embodiments consistent with the present disclosure.

### DETAILED DESCRIPTION

Some embodiments of this disclosure, illustrating its features, will now be discussed. The words “comprising”, “having”, “containing”, and “including”, and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a”, “an”, and “the” include plural references unless the context clearly dictates otherwise. Although any systems, methods, apparatuses, and devices similar or equivalent to those described herein can be used in the practice or testing of embodiments of the present disclosure, the preferred, systems and parts are now described. In the following description for the purpose of explanation and understanding reference has been made to numerous embodiments for which the intent is not to limit the scope of the disclosure.

One or more components of the disclosure are described as modules for the understanding of the specification. For example, a module may include self-contained component in a hardware circuit comprising of logical gate, semiconductor device, integrated circuits or any other discrete component. The module may also be a part of any software program executed by any hardware entity for example processor. The implementation of module as a software program may include a set of logical instructions to be executed by the processor or any other hardware entity. Further a module may be incorporated with the set of instructions or a program by means of an interface.

The disclosed embodiments are merely exemplary of the disclosure, which may be embodied in various forms. The present disclosure relates to an integrated system and method for compliance scrutiny and analysis of a software application. The results associated with compliance verification may be visually represented in order to demonstrate in-depth traceability of compliance level achieved by a particular software application. The system performs compliance verification of the application through features of the one or more analysis tools on selection of the compliance standard by the user. By way of a specific example, the analysis tool may include but is not limited to static analysis tools, static verification tool, test data generation, coverage analysis tool, coding standards compliance checker tool, or a combination thereof. The features of the analysis tool may be pre-mapped to the standard specifications and only these pre-mapped features may be further analyzed. The results of said analysis may be visually represented to showcase the compliance level in a multi-stage manner.

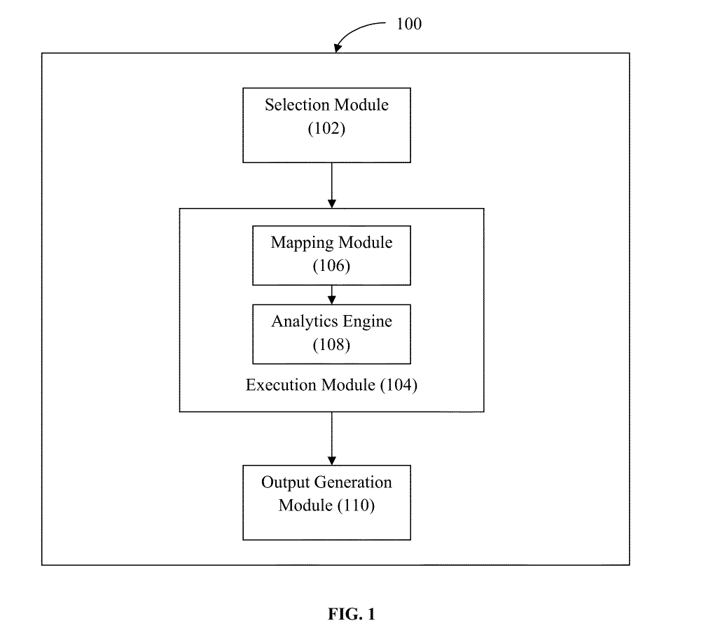

In accordance with an embodiment, referring to FIG. 1, the system (100) comprises of a selection module (102) which may be configured to allow a user to select one or more compliance standards pertinent to one or more industry. The system (100) further comprises of an execution module (104) which may be configured to initiate a process of compliance verification of said software application under test based on pre-defined mapping. The execution module (104) further comprises of a mapping module (106) and an analytics engine (108). The system (100) further comprises of an output generation module (110) to visually represent the results of the analytics engine to showcase the compliance of the software application in a multi-stage manner.

In accordance with an embodiment, still referring to FIG. 1, the selection module (102) may be configured to allow a user to select one or more compliance standards pertinent to one or more industry with respect to a particular safety level. The compliance standards applicable to any industry or an application may be different and therefore it may be necessary to select the appropriate compliance standards in order to perform an objective based compliance verification of the software application. The objective based compliance verification thus takes into consideration the choice of the user in the compliance level which he desires to achieve. The compliance standards available to check software quality compliance may include but is not limited to ISO26262. The selected compliance standards may have a safety criticality level, for e.g. ASIL (A/B/C/D) for ISO26262. Thus the user may be given an option of choosing from the existing ASIL safety criticality levels to perform the compliance verification.

The selected safety criticality level may be further grouped according to different standard specification (herein after referred to as ‘rule group’) which is to be complied with by the software application. By way of a specific example, ISO26262-ASIL Level D consists of rule groups such as Enforce Low Complexity, Semantic Code Analysis, Use Language Subsets, Enforce Strong Typing, No Implicit Type Conversions, Single Entry and Exit Point, Use Design Principles, Variables Initialization, No Multiple Variable Names, Use Defensive Implementation, No Recursions, MC/DC, Analysis of Boundary Values, Static Code Analysis. The rule group level specification further comprises of various rules. In accordance with the safety criticality level selected by the user the rules to be complied with can be categorized as mandatory rules, optional rules and suggested rules. The mandatory rules may be assigned the highest weight of 3, suggested (recommended) rules may carry a weight of 2, and optional rules assigned a weight of 1.

Still referring to FIG. 1, the execution module (104) may be configured to initiate a process of compliance verification of said software application with respect to one or more normative parameters associated with said safety level. The normative parameters may be the standard specifications and the rules to comply with by the software application. The execution module (104) further comprises of a mapping module (106) which may be configured to provide for pre-defined mapping of selected compliance standards with corresponding features of one or more analysis tool in order to perform compliance verification of the software application. These features may be then executed to analyze the software application under testing for calculating compliance standards. The mapping module (106) executes the pre-defined mapping in a manner such that mandatory rules may be pre-selected and may be non-configurable. The mapping module (106) may be further configured to provide the selection of optional or suggested rules by the user for further mapping. The mapping module (106) further comprises of a storage medium configured to save the pre-defined mapping for consistency across all the users of the tool. This selected configuration which can be saved using the mapping module (106) ensures uniformity in compliance check across all the users. The pre-defined mapping avoids the effort and confusion of mapping. The pre-defined mapping also absorbs the inherent complexity in the standard specifications and thus helps the users in understanding them. Also, as the time invested in understanding the complex standard specifications may be saved, the efficiency of the system increases resulting in faster execution. The mapping may be domain specific and thus the user gets custom fit framework wherein the automotive users can perform only auto-compliance checks.

The execution module (106) further comprises of an analytics engine (108) which may be configured to analyze only the pre-mapped features of the analysis tool(s) to calculate a compliance level for said software application. Internally, the selected rules may be mapped to the features of various analysis tools and only those features may be executed from one or more tools. The analytics engine (108) further identifies a number of rules violated with respect to total number of rules to calculate the compliance level for said software application.

By way of a specific example, let us understand the calculation of compliance level:

Generally Quality Standards Provide the various compliance suggestions e.g. from ISO26262

“++” The method may be highly recommended for this ASIL. (Mandatory)
“+” The method may be recommended for this ASIL. (Recommended)
“o” The method has no recommendation for or against its usage for this ASIL (Optional).

So there may be three levels, and the highest recommendation will carry weight 3 and optional will carry weight of 1.

Mt=Total no. of Mandatory

My=No. of Mandatory Rules violated

Rt=Total no. of Recommended Rules

Rv=No. of Recommended Rules violated

Ot=Selected total no. of Optional Rules

Ov=No. of selected Optional Rules violated

Mw=3 (Weight for Mandatory Rules)

Rw=2 (Weight for Recommended Rules)

Ow=1 (Weight for Optional Rules)

$$\% Non \text{-} compliance Level = \frac{( Mv * Mw ) + ( Rv * Rw ) + ( Ov * Ow )}{( M t * Mw ) + ( Rt * Rw ) + ( Ot * Ow )} * 100$$

$$\% Compliance Level = 100 - \% Non \text{-} compliance Level$$

Compliance levels may be calculated at module as well as at complete level.

Still referring to FIG. 1, the system (100) further comprises of an output generation module (110) which may be configured to visually represent results of the analytics engine to showcase the compliance of the software application in a multi-stage manner. The mining approach maps the compliance specifications/rules to the non-compliance/violation in the source code in staged manner. This helps to look at the non-compliance from various perspectives such as Rule/specification group level, rule/specification level, recommendation level and file level. The multi-stage manner may be determined through a result mining approach to provide one or more suggestive measures in order to meet a desired compliance level. The multi-stage manner provides in-depth traceability which includes but is not limited to visualization from the compliance grouping to the individual rule violations, from the individual rule violations to the detailed listing and from the detailed listing to a source code.

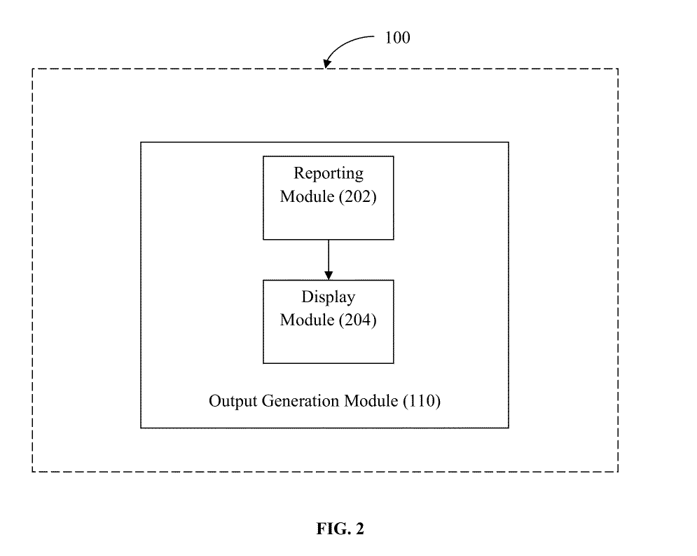

Referring to FIG. 2, the output generation module further comprises of a reporting module (202) configured to generate reports in one or more groups according to standard compliance grouping. The output generation module further includes a display module (204) configured to visually represent the results by means of a compliance indication bar. The compliance indicator bar color helps in identifying the percent compliance at each group level. When any mandatory requirement is not met, the compliance indicator bar may be red in color though the compliance percent may be high. When all the mandatory requirements are met and compliance level is greater than or equal to 85% then the compliance indicator bar shows in green color. When all the mandatory requirements are met and compliance level is less than 85% then the compliance indicator bar shows in orange color.

The present disclosure also relates to a computer program product, with embedded set of instructions, for determining a compliance level with respect to a software application quality certification. The computer program product comprises of a user interface which may be coupled to a processor. The user interface may be configured to receive one or more compliance standards selected by a user for the quality certification of said software application, pertinent to one or more industry with respect to a particular safety level.

The computer program product further comprises of a compliance level determination module which may be communicatively coupled to said user interface. The compliance level determination module may be configured to execute a pre-defined mapping of user selected compliance standards with corresponding features of one or more analysis tools in order to provide the user, a compliance level for said software application.

In addition, the computer program product comprises of a display module which may be configured to visually represent the compliance level of said software application in a multi-layer manner, such that each layer corresponds to a said pre-defined mapping. The display module may be further configured to display suggestive measures to the user for each rule violation in order to meet a desired compliance level. The reporting module may be further configured to generate reports in one or more groups according to standard compliance grouping and visually represent the results by means of a compliance indication bar.

The system and method illustrated to provide compliance scrutiny and analysis of a software application may be illustrated by working example stated in the following paragraph; the process is not restricted to the said example only.

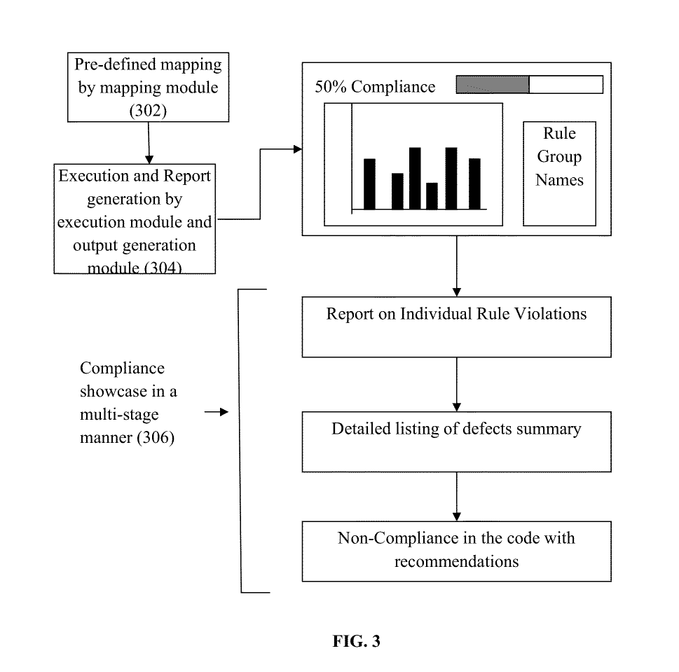

Referring to FIG. 3 in particular and other figures showing system architecture, let us consider a software application/project for which the software compliance verification has to be conducted for ISO26262. The safety criticality level to be selected may be ASIL-Level D. The user selects ISO26262-ASIL Level D through the selection module (102). On the selection of the standard specification, the mapping module (104) internally maps the features of the project with the individual rules (as shown in block 302) of rule group of ASIL level D. ISO26262-ASIL Level D consists of rule groups such as Enforce Low Complexity, Semantic Code Analysis, Use Language Subsets, Enforce Strong Typing, No Implicit Type Conversions, Single Entry and Exit Point, Use Design Principles, Variables Initialization, No Multiple Variable Names, Use Defensive Implementation, No Recursions, MC/DC, Analysis of Boundary Values, Static Code Analysis.

When the rule group, Enforce Low Complexity is selected, the rules in said group may be already mapped. As the ISO recommendation for ASIL-level D may be high all the rules mapped may be mandatory which carry the highest weight. These mandatory rules may be pre-selected and cannot be configured by the user. The mapping module (104) allows the user to save this selected mapping in order to ensure consistency across all the users working on the selected project.

In the next step, the user clicks on the Analyze button to start the execution process (as shown in block 304). Only the mapped features and the rules may be executed and after the successful execution the output generation module (110) generates reports in order to showcase the compliance in a multi-stage manner (as shown in block 306). All the reports may be grouped as per the standard compliance grouping for better understanding of the user. The compliance indicator bar showcases the percent compliance at each level. From the representation at the logical group level, the user can drill down to the individual rule violations which depicts how many times that particular rule has been violated. Further, the user can drill down to the detailed listing which gives a report of the defects summary. In the last step, the non-compliance at the level of the source code is depicted, wherein the line of the source code in which defect is present is highlighted. The detailed visualization provides the user with traceability from the non-compliance in rule group to the non-compliance in the code.

### Computer System

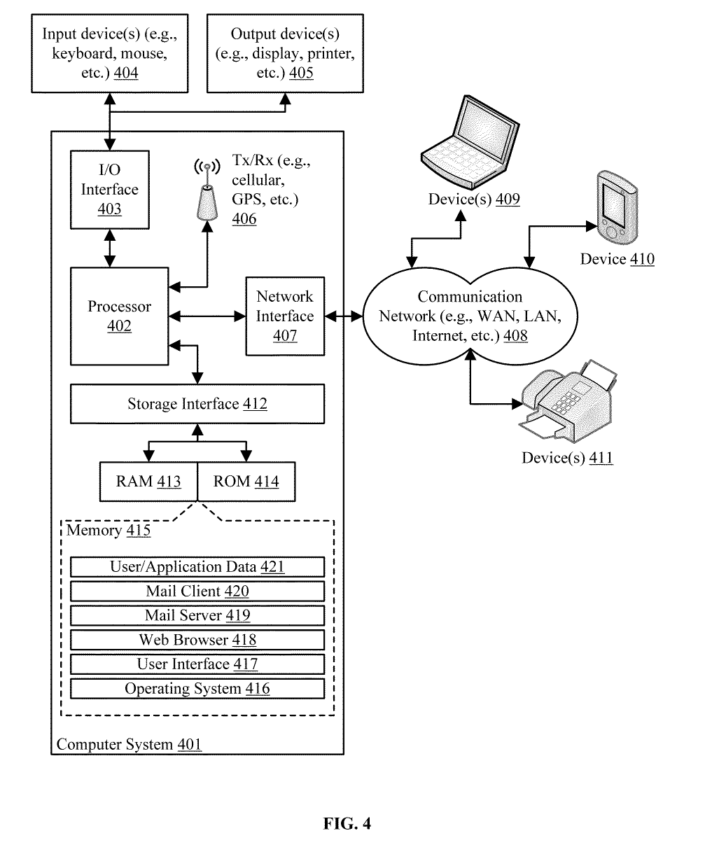

FIG. 4 is a block diagram of an exemplary computer system for implementing embodiments consistent with the present disclosure. Variations of computer system 401 may be used for implementing the devices and/or modules described above. Computer system 401 may comprise a central processing unit (“CPU” or “processor”) 402. Processor 402 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, mono aural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, modules, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The specification has described a system and method to provide compliance scrutiny and in-depth analysis of a software application. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

We claim:

1. A software compliance analysis system, comprising:
a processor; and
a memory storing processor-executable instructions, the instructions comprising:
a selection module configured to allow a user to select one or more industry compliance standards with respect to a particular safety level;
an execution module configured to initiate a compliance verification process for a software application with respect to one or more normative parameters associated with the safety level;
a mapping module configured to map the selected compliance standards with features of one or more analysis tools;
an analytics engine configured to analyze the mapped features of the one or more analysis tools to calculate a compliance level for the software application; and
an output generation module configured to visually represent compliance of the software application in a multi-stage manner providing one or more suggestive measures to meet a desired compliance level.

2. The system as claimed in claim 1, wherein the mapping module is configured for executing the mapping in a manner such that mandatory rules are pre-selected and are non-configurable.

3. The system as claimed in claim 1, wherein the mapping module is further configured to provide a selection of optional or suggested rules by the user for further mapping.

4. The system as claimed in claim 1, wherein the mapping module is further configured to save the mapping for consistency across all the users of the tool.

5. The system as claimed in claim 1, wherein the analytics engine is further configured to identify a number of rules violated with respect to total number of rules to calculate the compliance level.

6. The system as claimed in claim 1, wherein the instructions further comprises a reporting module configured to generate reports in one or more groups according to standard compliance grouping.

7. The system as claimed in claim 1, wherein the output generation module is configured to provide visualizations regarding compliance grouping, individual rule violations, and source code.

8. The system as claimed in claim 1, wherein the output generation module is configured to visually represent the results via a compliance indication bar.

9. A software compliance analysis method, comprising:
allowing a user to select one or more industry compliance standards with respect to a particular safety level;
initiating a compliance verification process for the software application with respect to one or more normative parameters associated with the safety level;
mapping the selected compliance standards with features of one or more analysis tools;
analyzing only the mapped features of the one or more analysis tools to calculate a compliance level for the software application; and
visually representing compliance of the software application in a multi-stage manner providing one or more suggestive measures to meet a desired compliance level.

10. The method as claimed in claim 9, wherein the mapping is executed in a manner such that mandatory rules are pre-selected and are non-configurable.

11. The method as claimed in claim 9, wherein the mapping further provides a selection of optional or suggested rules by the user for further mapping.

12. The method as claimed in claim 9, further comprising:
saving the mapping for consistency across all the users of the tool.

13. The method as claimed in claim 9, wherein the analyzing further comprises:
identifying a number of rules violated with respect to total number of rules to calculate the compliance level.

14. The method as claimed in claim 9, wherein the reports are generated in one or more groups according to standard compliance grouping.

15. The method as claimed in claim 9, wherein the visually representing provides visualizations regarding compliance grouping, individual rule violations, and source code.

16. The method as claimed in claim 9, wherein the results are visually represented via a compliance indication bar.

17. A non-transitory computer-readable medium storing computer-executable instructions, the instructions comprising instructions for:
a user interface configured to receive a selection from a user of one or more industry compliance standards with respect to a particular safety level;
a compliance level determination module configured to execute a mapping of the selected compliance standards with features of one or more analysis tools;
a display module configured to visually represent a compliance level of said software application in a multi-layer manner, such that each layer corresponds to the mapping, the display module further configured to display suggestive measures to the user for each rule violation to meet a desired compliance level.

18. The computer program product as claimed in claim 17, wherein the display module is further configured to generate reports in one or more groups according to standard compliance grouping.

19. The computer program product as claimed in claim 17, wherein the display module is further configured to visually represent the results via a compliance indication bar.
